(19) United States
(12) Patent Application Publication
(10) Pub. No.: US 2012/0206924 A1
(43) Pub. Date: Aug. 16, 2012

(54) LASER LIGHT SHAPING OPTICAL SYSTEM

(75) Inventors: Haruyasu Ito, Hamamatsu-shi (JP); Takashi Yasuda, Hamamatsu-shi (JP)

(73) Assignee: HAMAMATSU PHOTONICS K.K., Hamamatsu-shi (JP)

(21) Appl. No.: 13/357,889

(22) Filed: Jan. 25, 2012

(30) Foreign Application Priority Data
Feb. 14, 2011 (JP) 2011-028839

(51) Int. Cl. F21V 5/04

(52) U.S. Cl. 362/335; 362/326

(57) ABSTRACT

A laser light shaping optical system 1 in accordance with an embodiment of the present invention comprises an intensity conversion lens 11 for converging and shaping an intensity distribution of laser light incident thereon into a desirable intensity distribution; a phase correction lens 12 for correcting the laser light emitted from the intensity conversion lens 11 into a plane wave by homogenizing a phase thereof; and an expansion/reduction optical system 20, arranged between the intensity conversion lens 11 and the phase correction lens 12, for expanding or reducing the laser light emitted from the intensity conversion lens 11.

### BACKGROUND OF THE INVENTION

1. Field of the Invention

The present invention relates to an optical system which shapes an intensity distribution of laser light into a given intensity distribution.

2. Related Background Art

Laser light typically has an intensity distribution which is the strongest near its center and gradually becomes weaker toward peripheries as in a Gaussian distribution. However, laser light having a spatially uniform intensity distribution has been desired for laser processing and the like.

In this regard, Patent Literature 1 discloses, as a laser light shaping optical system for shaping an intensity distribution of laser light into a spatially uniform intensity distribution (e.g., a top-hat intensity distribution), one comprising an aspherical lens type homogenizer constituted by an intensity conversion lens and a phase correction lens. The laser light shaping optical system disclosed in Patent Literature 1 further comprises an image-forming optical system (transfer lens system) on the downstream side of the homogenizer in order to suppress the unevenness in the intensity distribution caused by positional deviations between the intensity conversion lens and the phase correction lens.

Patent Literature 2 discloses, as a laser light shaping optical system for shaping the intensity distribution of laser light into a spatially uniform intensity distribution, one comprising the above-mentioned aspherical lens type homogenizer, a diffractive homogenizer constituted by a diffractive optical element (DOE), or the like. The laser light shaping optical system disclosed in Patent Literature 2 further comprises, on the downstream side of the homogenizer, an image-forming optical system constituted by an objective lens and an image-forming lens arranged behind the objective lens. For reducing the total length of the laser light shaping optical system, the objective lens is arranged in front of a focal plane of the homogenizer, so as to have a negative focal length.

Meanwhile, there are cases where this kind of optical systems expand or reduce the laser light depending on sizes and specs of components arranged within the optical systems. For example, when arranging a spatial light modulator (SLM) within an optical system, it is preferred to expand or reduce laser light such that the size of the laser light substantially equals that of the modulation surface of the SLM.

In this regard, the laser light shaping optical systems disclosed in Patent Literatures 1 and 2 seem to be able to easily expand or reduce the laser light by using the image-forming optical system disposed behind the homogenizer.
Patent Literature 1: Japanese Patent Application Laid-Open No. 2007-310368
Patent Literature 2: Japanese Patent Application Laid-Open No. 2007-114741

### SUMMARY OF THE INVENTION

Arranging an expansion/reduction optical system behind the homogenizer as mentioned above may be problematic in that the number of parts or the optical path length increases. In this regard, the inventors have tried to homogenize the intensity distribution of laser light and expand or reduce the laser light at the same time by using a pair of aspherical lenses (an intensity conversion lens and a phase correction lens) in the homogenizer alone.

However, new problems have occurred as follows. That is, it complicates the form of the aspheric surface of the intensity conversion lens and increases the area of the intensity conversion lens and the difference in height of the aspheric surface. As a result, the processing time required for manufacturing the intensity conversion lens becomes longer, thereby increasing the manufacturing cost and lowering the processing accuracy. Also, this kind of intensity conversion lens may not be employed in existing optical systems with limited mounting spaces.

It is therefore an object of the present invention to provide, in a laser light shaping optical system which shapes an intensity distribution of laser light into a given intensity distribution, one which inhibits the processing time for optical lenses from being prolonged by expanding or reducing the laser light.

The laser light shaping optical system in accordance with the present invention comprises an intensity conversion lens for converging and shaping an intensity distribution of laser light incident thereon into a desirable intensity distribution; a phase correction lens for correcting the laser light emitted from the intensity conversion lens into a plane wave by homogenizing a phase thereof; and an expansion/reduction optical system, arranged between the intensity conversion lens and the phase correction lens, for expanding or reducing the laser light emitted from the intensity conversion lens.

Since this laser light shaping optical system expands or reduces laser light by using the expansion/reduction optical system arranged between the intensity conversion lens and the phase correction lens, it is sufficient for the intensity conversion lens to shape the intensity distribution of the laser light. This can inhibit the intensity conversion lens from increasing the difference in height in its aspheric surface, thereby keeping the intensity conversion lens from prolonging its processing time. This can also inhibit the phase correction lens from increasing the difference in height in its aspheric surface, thereby keeping the intensity phase correction lens from prolonging its processing time (which will be explained later in detail).

The expansion/reduction optical system may be constituted by a pair of convex lenses or a pair of concave and convex lenses. This structure can expand or reduce the laser light to a given size according to focal lengths of the pair of lenses.

When practical use is taken into consideration here, the expansion/reduction optical system constituted by a pair of convex lenses once converges (crosses) a beam and then expands or reduces it, which increases the optical path length and may cause air breakdown at the converging point (cross point). In terms of optical design, on the other hand, another optical element (such as a reflector for monitoring) cannot be arranged within the expansion/reduction optical system even when required, since the light intensity is so strong near the converging point that the optical element may be damaged.

By contrast, the expansion/reduction optical system constituted by a pair of concave and convex lenses has no converging point (cross point) and thus can reduce the optical path length while preventing air breakdown from occurring at the converging point. Also, optical elements arranged within the expansion/reduction optical system, if any, are not damaged, which is advantageous in that the degree of freedom in optical design is high, whereby further smaller sizes can be achieved.

In a laser light shaping optical system which shapes an intensity distribution of laser light into a given intensity distribution, the present invention can inhibit the processing time for optical lenses from being prolonged by expanding or reducing the laser light.

### BRIEF DESCRIPTION OF THE DRAWINGS

FIG. 1 is a structural diagram illustrating an example of homogenizers;

FIG. 2 is a chart illustrating respective examples of intensity distributions of input laser light and output laser light in the homogenizer;

FIG. 3 is a chart illustrating an example of forms of intensity conversion lenses;

FIG. 4 is a chart illustrating an example of forms of phase correction lenses;

FIG. 5 is a chart illustrating an example of intensity distributions of input laser light in the homogenizer;

FIG. 6 is a chart illustrating an example of desirable intensity distributions of output laser light in the homogenizer;

FIG. 7 is a chart illustrating an example of forms of intensity conversion lenses;

FIG. 8 is a chart illustrating an example of forms of phase correction lenses;

FIG. 9 is a chart illustrating an example of desirable intensity distributions of output laser light in the homogenizer;

FIG. 10 is a chart illustrating an example of forms of intensity conversion lenses;

FIG. 11 is a chart illustrating an example of forms of phase correction lenses;

FIG. 12 is a structural diagram illustrating the laser shaping optical system in accordance with a first embodiment of the present invention;

FIG. 13 is a structural diagram illustrating the laser shaping optical system in accordance with a first example;

FIG. 14 is a chart illustrating a result of measurement of the intensity distribution of input laser light;

FIG. 15 is a chart illustrating a result of design of the intensity conversion lens in the first example;

FIG. 16 is a chart illustrating a result of measurement of a desirable intensity distribution of the laser light emitted from the intensity conversion lens in the first example at a position where the phase correction lens is arranged;

FIG. 17 is a chart illustrating a result of measurement of the wavefront of the laser light emitted from the intensity conversion lens in accordance with the first example at the position where the phase correction lens is arranged;

FIG. 18 is a chart illustrating a result of design of the phase correction lens in the first example;

FIG. 19 is a structural diagram illustrating the laser light shaping optical system in accordance with a first comparative example;

FIG. 20 is a chart illustrating a result of measurement of a desirable intensity distribution of the laser light emitted from the intensity conversion lens in the first comparative example at the position where the phase correction lens is arranged;

FIG. 21 is a chart illustrating a result of measurement of the wavefront of the laser light emitted from the intensity conversion lens in the first comparative example at the position where the phase correction lens is arranged;

FIG. 22 is a chart illustrating a result of design of the phase correction lens in the first comparative example;

FIG. 23 is a structural diagram illustrating the laser light shaping optical system in accordance with a second embodiment (second example);

FIG. 24 is a chart illustrating a result of measurement of a desirable intensity distribution of the laser light emitted from the intensity conversion lens in the second example at the position where the phase correction lens is arranged;

FIG. 25 is a chart illustrating a result of measurement of the wavefront of the laser light emitted from the intensity conversion lens in the second example at the position where the phase correction lens is arranged;

FIG. 26 is a structural diagram illustrating the laser light shaping optical system in accordance with a third embodiment (third example);

FIG. 27 is a chart illustrating a result of measurement of a desirable intensity distribution of the laser light emitted from the intensity conversion lens in the third example at the position where the phase correction lens is arranged;

FIG. 28 is a chart illustrating a result of measurement of the wavefront of the laser light emitted from the intensity conversion lens in the third example at the position where the phase correction lens is arranged;

FIG. 29 is a chart illustrating a result of design of the phase correction lens in the third comparative example;

FIG. 30 is a structural diagram illustrating the laser light shaping optical system in accordance with a fourth embodiment (fourth example);

FIG. 31 is a chart illustrating a result of measurement of a desirable intensity distribution of the laser light emitted from the intensity conversion lens in the fourth example at the position where the phase correction lens is arranged; and

FIG. 32 is a chart illustrating a result of measurement of the wavefront of the laser light emitted from the intensity conversion lens in the fourth example at the position where the phase correction lens is arranged.

### DESCRIPTION OF THE PREFERRED EMBODIMENTS

In the following, preferred embodiments of the present invention will be explained in detail with reference to the drawings. In the drawings, the same or equivalent parts will be referred to with the same signs.

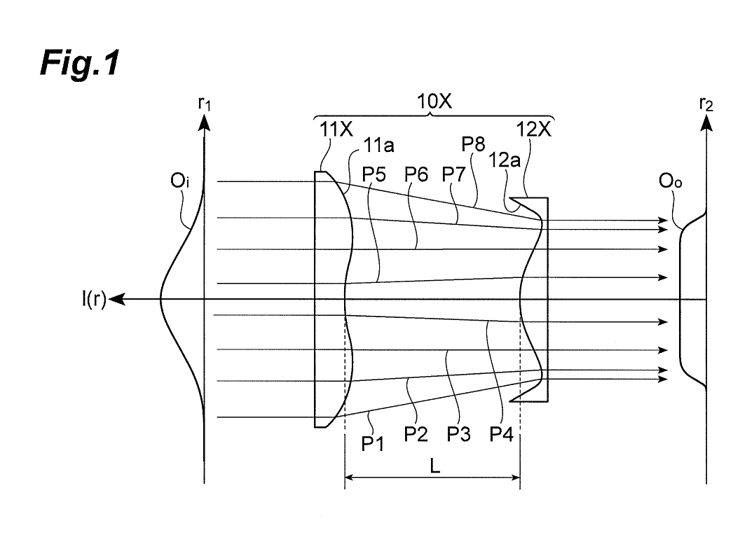

Before explaining the embodiments of the present invention, a homogenizer and a technique for designing the form of an aspheric surface of the homogenizer will be explained. FIG. 1 is a structural view illustrating an example of homogenizers. This homogenizer 10X is used for shaping an intensity distribution of laser light into a given form and comprises a pair of aspherical lenses 11X, 12X. The aspherical lens 11X on the entrance side functions as an intensity conversion lens for shaping the intensity distribution of laser light into a given form, while the aspherical lens 12X on the exit side functions as a phase correction lens for homogenizing a phase of the shaped laser light, so as to correct it into a plane wave. By designing the forms of the aspheric surfaces in the pair of aspherical lenses 11X, 12X, this homogenizer 10X can produce output laser light Oo having a desirable intensity distribution into which the intensity distribution of input laser light Oi is shaped according to the designed forms of the aspheric surfaces in the pair of aspherical lenses 11X, 12X.

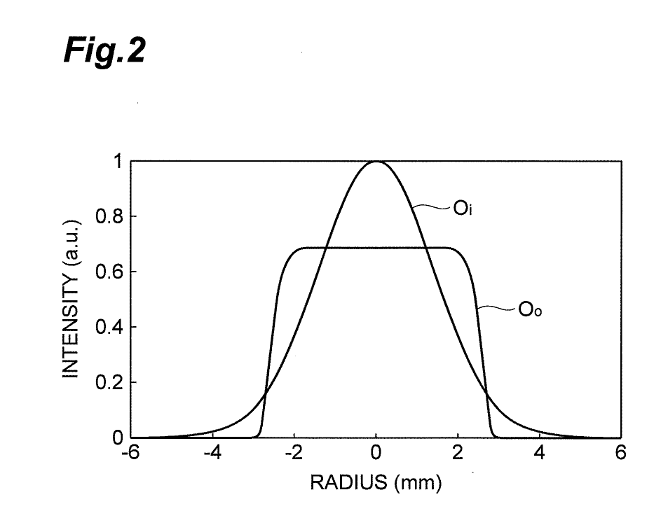

The following will illustrate an example of designing the forms of the aspheric surfaces in the intensity conversion lenses 11X, 12X in the homogenizer 10X. For example, the desirable intensity distribution is supposed to be set to a spatially uniform intensity distribution which is desired for laser processing apparatus, optical tweezers, high-resolution microscopes, and the like, i.e., a uniform intensity distribution (Oo in FIG. 2). Here, it is necessary for the desirable intensity distribution to be set such that the energy of the output laser light Oo (area of the desirable intensity distribution) equals the energy of the input laser light Oi (area of the intensity distribution). Hence, the uniform intensity distribution is set as follows, for example.

As illustrated in FIG. 2, the intensity distribution of the input laser light Oi is a concentric Gaussian distribution (wavelength: 1064 nm; beam diameter: 5.6 mm at 1/e²; ω=2.0 mm). Since the Gaussian distribution is represented by the following expression (1), the energy of the input laser light Oi within the range of a radius of 6 mm is obtained by the following expression (2):

$$\begin{matrix}[ Mathematical expression 1 ] & \\ {I}_{1} ( r ) = exp \{ - {( \frac{r}{ω} )}^{2} \} & ( 1 ) \\ [ Mathematical expression 2 ] & \\ {\int }_{- 6}^{6} {I}_{1} ( r ) d r = 1.76689 & ( 2 )\end{matrix}$$

In this case, the Gaussian distribution is rotationally symmetric about a radius of 0 mm, whereby the aspheric surface form is designed by one-dimensional analysis.

On the other hand, the desirable intensity distribution of the output laser light Oo is set to a uniform intensity distribution (order N=8; ω=2.65 mm) as illustrated in FIG. 2. Since the uniform intensity distribution is represented by the following expression (3), the value of the uniform intensity part of the output laser light Oo is set as E₀=0.687 in order for the energy within the radius of 6 mm of the output laser light Oo to equal the energy of the input laser light Oi as in the following expression (4):

$$\begin{matrix}[ Mathematical expression 3 ] & \\ {I}_{2} ( r ) = {E}_{0} \times exp \{ - {( \frac{r}{ω} )}^{2 N} \} & ( 3 ) \\ [ Mathematical expression 4 ] & \\ {\int }_{- 6}^{6} {I}_{1} ( r ) d r = {\int }_{- 6}^{6} {I}_{2} ( r ) d r & ( 4 )\end{matrix}$$

According to this technique, the desirable intensity distribution of the shaped output laser light can not only follow a specified function, but also become a given intensity distribution.

Subsequently, as illustrated in FIG. 1, optical paths P1 to P8 which are optical paths from the aspheric surface 11a of the intensity conversion lens 11X to the aspheric surface 12a of the phase correction lens 12X at given coordinates in the radial direction of the intensity conversion lens 11X are determined such that the intensity distribution of the input laser light Oi at the intensity conversion lens 11X becomes the desirable intensity distribution of the output laser light Oo at the phase correction lens 12X, i.e., such that light having a stronger intensity near the center in the input laser light Oi diffuses to peripheral parts, while light having a weaker intensity in the peripheral parts converges.

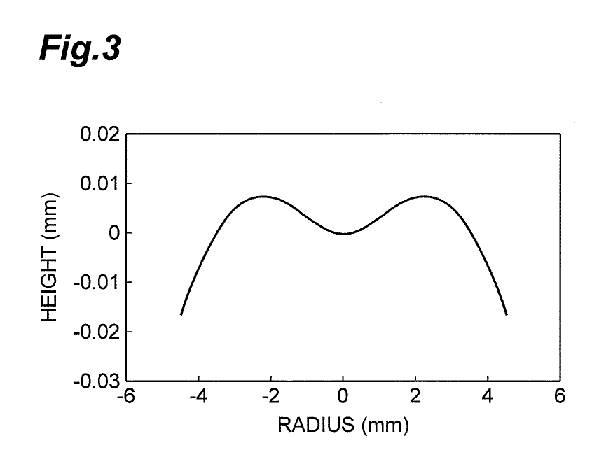

Thereafter, according to thus determined optical paths P1 to P8, the form of the aspheric surface 11a of the intensity conversion lens 11X is determined. Specifically, with reference to the center of the intensity conversion lens 11X, the difference in height of the aspheric surface 11a is determined at each coordinate in the radial direction r₁ so as to yield the optical paths P1 to P8. Then, the form of the aspheric surface 11a of the intensity conversion lens 11X is determined as illustrated in FIG. 3.

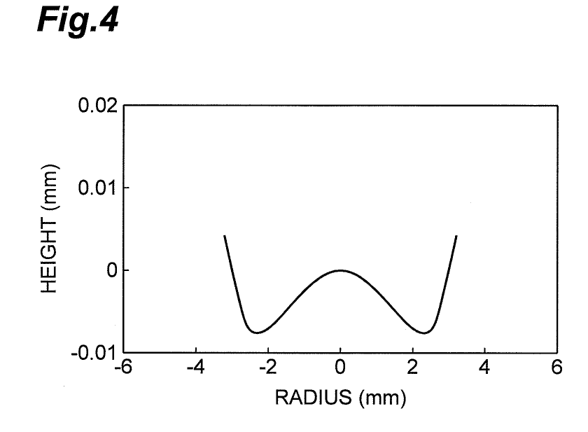

On the other hand, the form of the aspheric surface 12a of the phase correction lens 12X is determined such as to make the laser light have a uniform phase on the optical paths P1 to P8 and become a plane wave. Specifically, with reference to the center of the phase correction lens 12X, the difference in height of the aspheric surface 12a is determined at each coordinate in its radial direction r₂. Then, the form of the aspheric surface 12a of the intensity conversion lens 12X is determined as illustrated in FIG. 4.

FIGS. 3 and 4 are examples of designing in which CaF₂ (n=1.42) is used as a material for the aspherical lenses 11X, 12X, while the distance between the center position (where coordinate r₁=0) of the aspheric surface 11a and the center position (where coordinate r₂=0) of the aspheric surface 12a is set as L=165 mm.

According to the idea of the inventors, when the expansion or reduction of the beam diameter of the laser light is also taken into consideration in the above-mentioned designing of the forms of the aspheric surfaces, the pair of aspherical lenses 11X, 12X in the homogenizer 10X by themselves can shape the intensity distribution of the input laser light Oi into a desirable intensity distribution and produce the output laser light Oo having expanded or reduced its beam diameter to a desirable size.

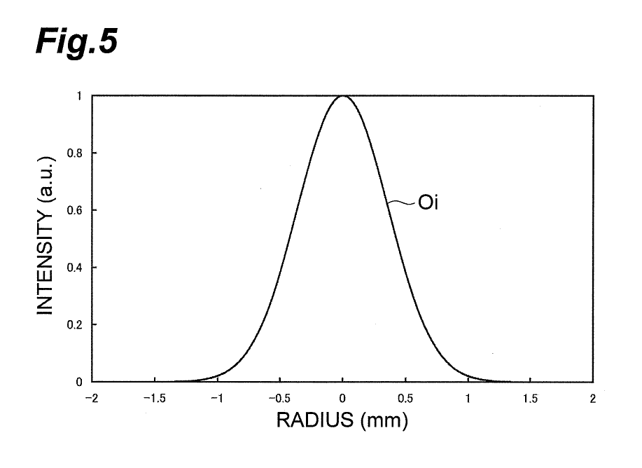

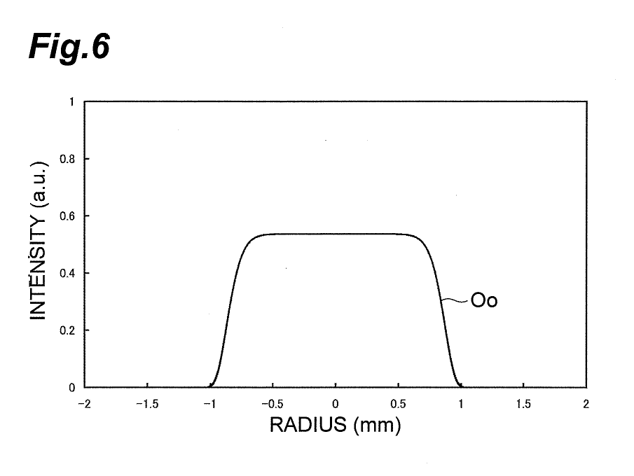

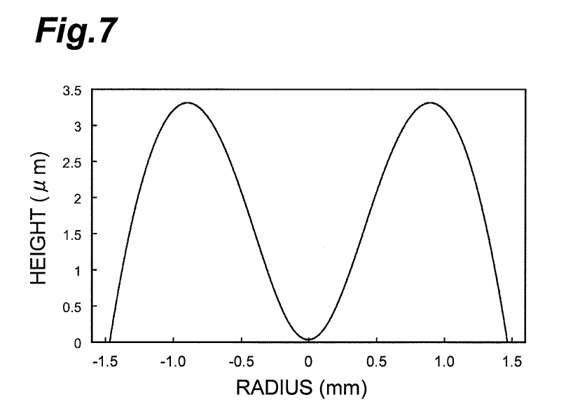

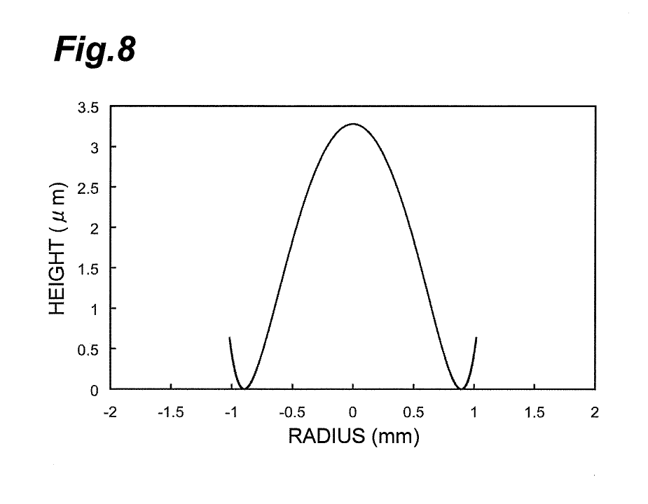

For example, suppose that the input laser light Oi having an intensity distribution which is a concentric Gaussian distribution (with a wavelength of 1064 nm and a beam diameter of 1.44 mm at 1/e²) as illustrated in FIG. 5 is shaped into a uniform intensity distribution (with an order of 6 and a beam diameter of 2.482 mm at 1/e²) as illustrated in FIG. 6, while generating output laser light Oo with an expanded beam diameter. In this case, according to the form design of the aspheric surface mentioned above, the form of the aspheric surface 11a of the intensity conversion lens 11X is determined as illustrated in FIG. 7, and the form of the aspheric surface 12a of the phase correction lens 12X is determined as illustrated in FIG. 8.

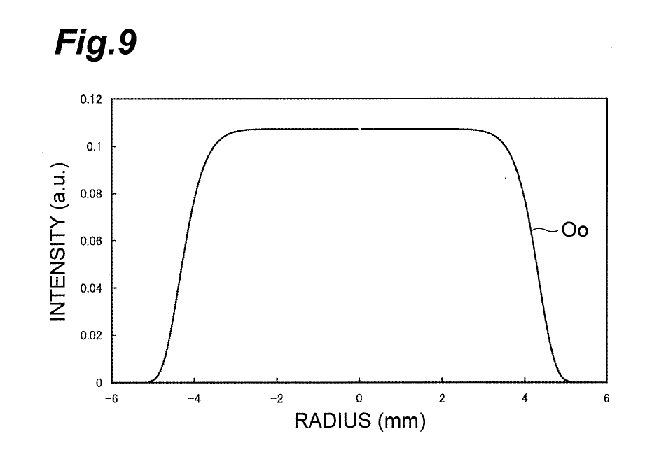

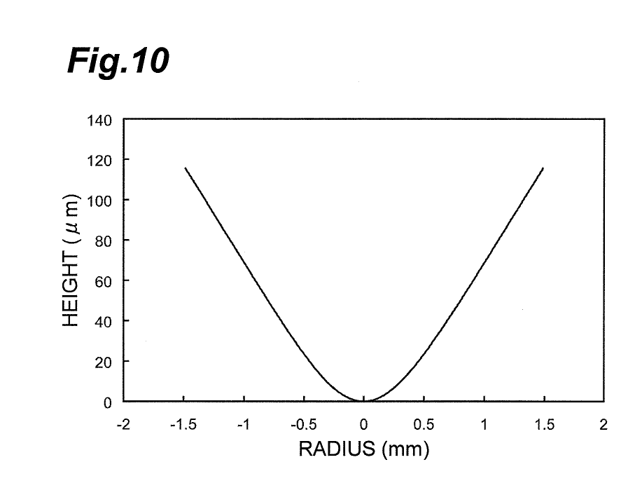

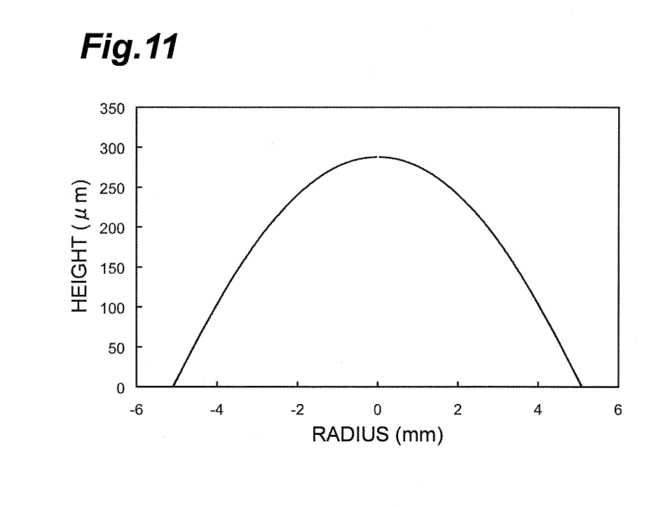

For example, suppose that the input laser light Oi having an intensity distribution which is the concentric Gaussian distribution illustrated in FIG. 5 is shaped into a uniform intensity distribution (with an order of 6 and a beam diameter of 12.41 mm at 1/e²) as illustrated in FIG. 9, while generating output laser light Oo with a further expanded beam diameter. In this case, according to the form design of the aspheric surface mentioned above, the form of the aspheric surface 11a of the intensity conversion lens 11X is determined as illustrated in FIG. 10, and the form of the aspheric surface 12a of the phase correction lens 12X is determined as illustrated in FIG. 11.

FIGS. 7, 8, 10, and 11 are examples of design using MgF₂ (n=1.377) as a material for the aspherical lenses 11X, 12X and setting the distance between the center position (where coordinate r₁=0) of the aspheric surface 11a and the center position (where coordinate r₂=0) of the aspheric surface 12a as L=100 mm.

For clarifying how the difference in height varies between the aspheric surfaces, the origin (the position where the height is 0 μm) of the ordinates differs from the center (where coordinate r₁=r₂=0) of the aspherical lenses 11X, 12X in FIGS. 7, 8, 10, and 11.

According to FIGS. 7 and 10, expanding the beam diameter by 12.41/2.482=5 times increases the difference in height of the aspheric surface of the intensity conversion lens 11X, thereby enhancing the amount of processing the aspheric surface of the intensity conversion lens 11X by about 34 times in terms of volume ratio. According to FIGS. 8 and 11, expanding the beam diameter by 5 times increases the area of the phase correction lens 12X and the difference in height of its aspheric surface, thereby enhancing the amount of processing the aspheric surface of the phase correction lens 12X by about 2140 times in terms of volume ratio.

Thus, when the magnifying or reducing power by the homogenizer, i.e., a pair of aspherical lenses, alone is set greater, namely, when trying to homogenize the intensity distribution of the laser light and expand or reduce the laser light at the same time by a pair of aspherical lenses alone, the aspherical lenses increase their area and difference in height of their aspheric surfaces, whereby the amount of processing the aspheric surfaces of the aspherical lenses becomes greater. This prolongs the processing time required for making the aspherical lenses, thereby increasing the manufacturing cost.

When trying to homogenize the intensity distribution of the laser light and expand or reduce the laser light at the same time by a pair of aspherical lenses alone, the ratio of the component for homogenizing the intensity distribution decreases as compared with the component for expanding or reducing the beam diameter, so that the action of expanding or reducing the beam diameter may become dominant depending on the magnifying or reducing power, whereby the action of homogenizing the intensity distribution may not fully be obtained.

Therefore, in a laser light shaping optical system which shapes an intensity distribution of laser light into a given intensity distribution, the inventors devise one which inhibits the processing time for optical lenses from being prolonged by expanding or reducing the laser light.

### First Embodiment

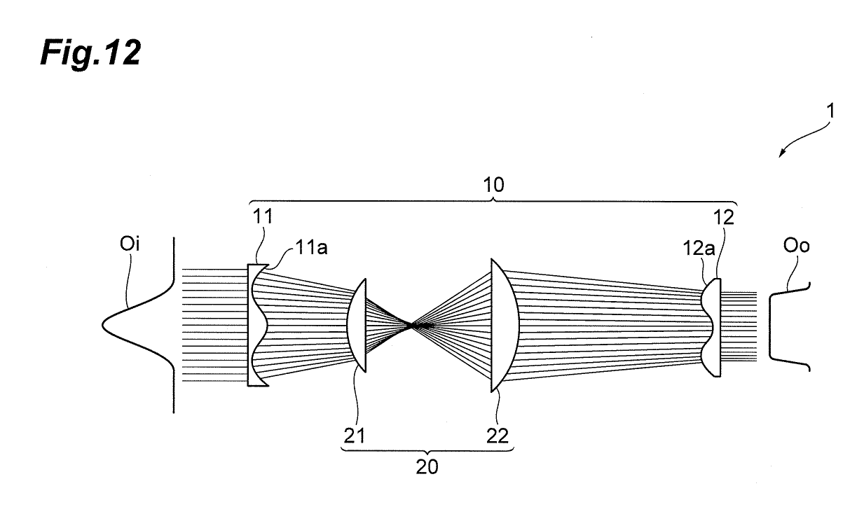

FIG. 12 is a structural diagram illustrating the laser light shaping optical system in accordance with the first embodiment of the present invention. This laser light shaping optical system 1 in accordance with the first embodiment comprises a homogenizer 10 constituted by a pair of aspherical lenses 11, 12 and an expansion optical system 20 disposed between the pair of aspherical lenses 11, 12.

As with the above-mentioned homogenizer 10X, the homogenizer 10 is used for shaping an intensity distribution of laser light into a given form and comprises the pair of aspherical lenses 11, 12. The aspherical lens 11 on the entrance side functions as an intensity conversion lens for shaping the intensity distribution of the laser light into a given form as with the above-mentioned aspherical lens 11X. On the other hand, as with the above-mentioned aspherical lens 12X, the aspherical lens 12 on the exit side functions as a phase correction lens for homogenizing the phase of the shaped laser light, so as to correct it into a plane wave. More specifically, the phase correction lens 12 homogenizes the phase of the laser light having the intensity distribution shaped by the intensity conversion lens 11 and then the beam diameter expanded by the expansion optical system 20, which will be explained later, so as to correct it into a plane wave. As mentioned above, by designing the forms of the aspheric surfaces 11a, 12a in the pair of aspherical lenses 11, 12, the homogenizer 10 can also produce the output laser light Oo having a desirable intensity distribution into which the intensity distribution of the input laser light Oi is shaped. The expansion optical system 20 is placed between the intensity conversion lens 11 and the phase correction lens 12.

The expansion optical system 20 is used for expanding the beam diameter of the laser light emitted from the intensity conversion lens 11 and comprises a pair of convex lenses 21, 22. The convex lens 21 is arranged on the intensity conversion lens 11 side and has a convex entrance surface and a planar exit surface. On the other hand, the convex lens 22 is arranged on the phase correction lens 12 side and has a planar entrance surface and a convex exit surface. A converging point exists between the pair of convex lenses 21, 22 in the expansion optical system 20. According to the respective focal lengths of the pair of convex lenses 21, 22, the expansion optical system 20 can expand the beam diameter of the laser light emitted from the intensity conversion lens 11 into a given size.

In the laser light shaping optical system 1 in accordance with the first embodiment, the expansion optical system 20 arranged between the intensity conversion lens 11 and the phase correction lens 12 expands the laser light, whereby it is sufficient for the intensity conversion lens 11 to shape the intensity distribution of the laser light. This can inhibit the intensity conversion lens 11 from increasing the difference in height of its aspheric surface and prolonging its processing time. This can also inhibit the phase correction lens 12 from increasing the difference in height of its aspheric surface and prolonging its processing time (which will be explained later in detail).

### First Example

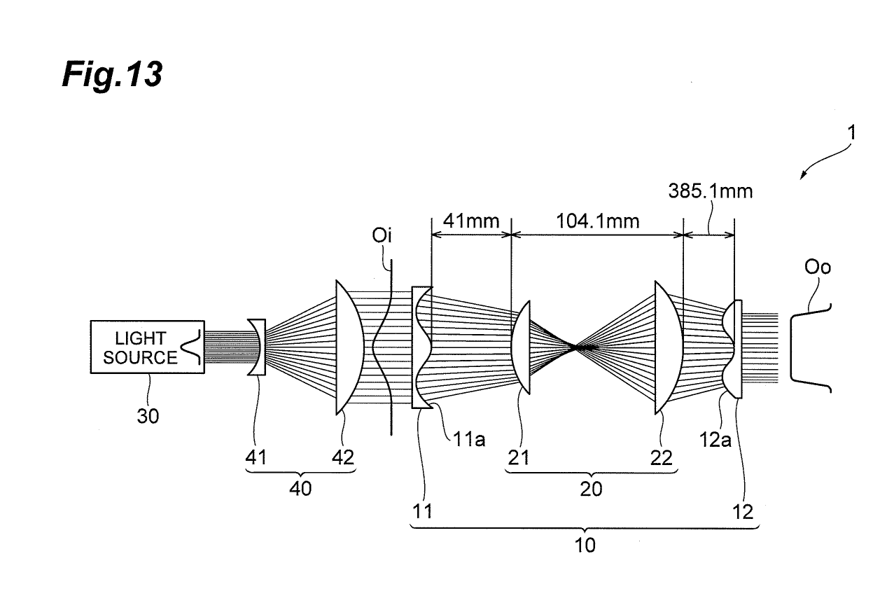

The laser light shaping optical system 1 in accordance with the first embodiment was designed as a first example. In the first example, as illustrated in FIG. 13, the laser light generated by a laser light source 30 was supposed to be expanded by an expander 40 and then made incident on the laser light shaping optical system 1.

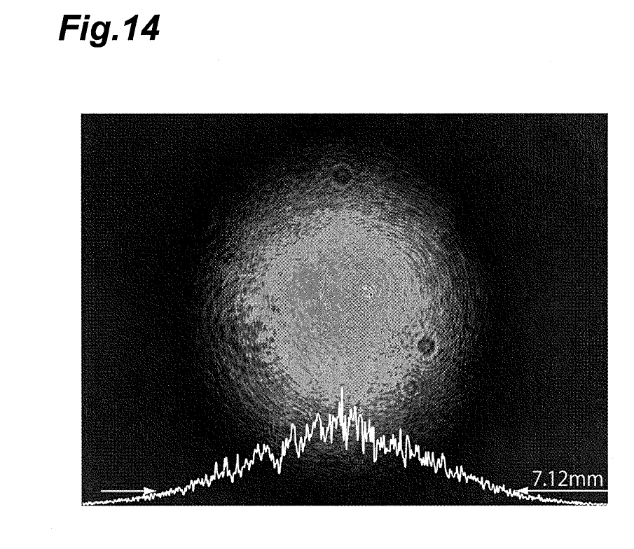

A fiber laser having a wavelength of 1064 nm was used as the laser light source 30, while employed as the expander 40 was one constituted by a pair of concave and convex lenses 41, 42. In this example, laser light Oi having expanded the laser light from the laser light source 30 to a diameter of 7.12 mm as illustrated in FIG. 14 was produced by the expander 40. According to FIG. 14, the intensity distribution of the laser light Oi incident on the laser light shaping optical system 1 was a concentric Gaussian distribution.

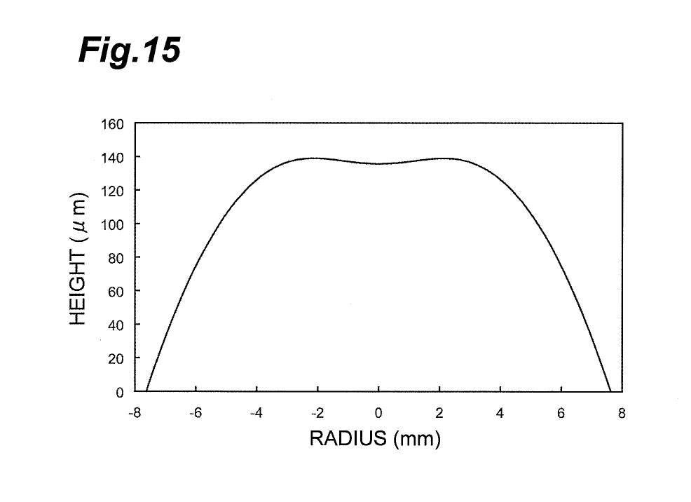

Then, as in the form design of the aspheric surface mentioned above, the form of the aspheric surface 11a of the intensity conversion lens 11 was determined as illustrated in FIG. 15.

Employed in the expansion optical system 20 were a condenser lens 21 made of BK7 having a thickness of 4.6 mm and a focal length of 41 mm and a condenser lens 22 made of BK7 having a thickness of 3.6 mm and a focal length of 61.5 mm.

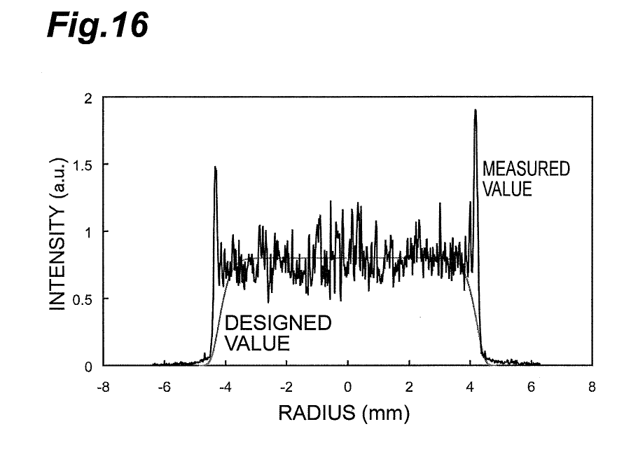

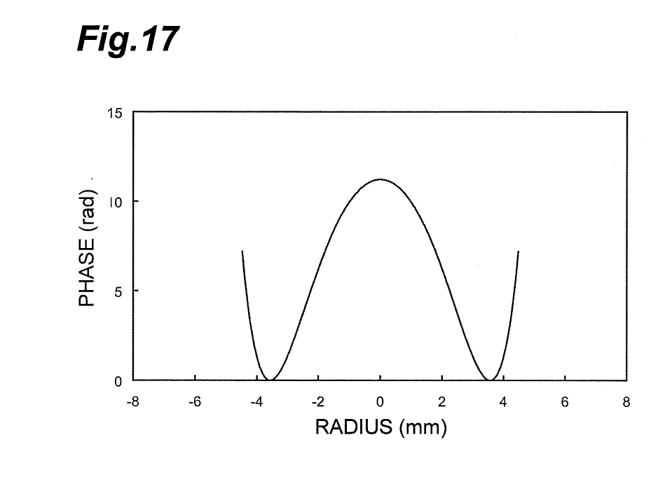

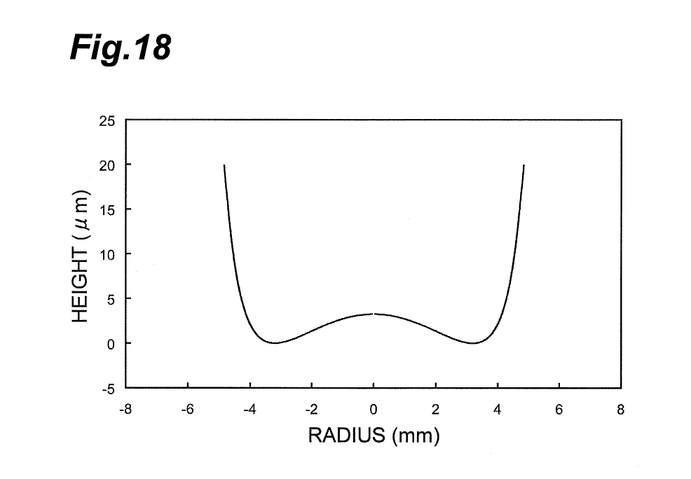

Then, as illustrated in FIG. 16, a desirable intensity distribution was obtained at 530 mm from the intensity conversion lens 11. FIG. 17 illustrates the wavefront of the laser light measured at this position. As in the form design of the aspheric surface mentioned above, the form of the aspheric surface 12a of the phase correction lens 12 at 530 mm from the intensity conversion lens 11 was determined as illustrated in FIG. 18.

Here, the design was made while using MgF₂ (n=1.377) as a material for the intensity conversion lens 11 and phase correction lens 12, setting the distance between the center position of the aspheric surface 11a and the center position of the aspheric surface 12a in the state without the expansion optical system 20 as L=215 mm, and taking account of the change in the optical path caused by inserting the expansion optical system 20 therein. In FIGS. 15 and 18, for clarifying how the difference in height of the aspheric surfaces varies, the origin (the position where the height is 0 μm) of the ordinate differs from the centers (where the radius is 0 mm) of the aspherical lenses 11, 12.

### First Comparative Example

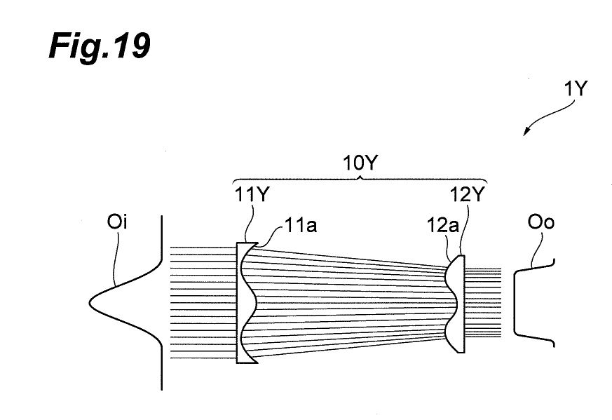

A laser light shaping optical system 1Y illustrated in FIG. 19 was designed as a first comparative example. The laser light shaping optical system 1Y in accordance with the first comparative example was different from that of the first example in that it lacked the expansion optical system 20 of the laser light shaping optical system 1.

The laser light generated by the laser light source 30 was supposed to be expanded by the expander 40 and then made incident on the laser light shaping optical system 1Y in the first comparative example as well. Therefore, the form of the aspheric surface 11a of the intensity conversion lens 11Y was the same as that of the aspheric surface 11a of the intensity conversion lens 11.

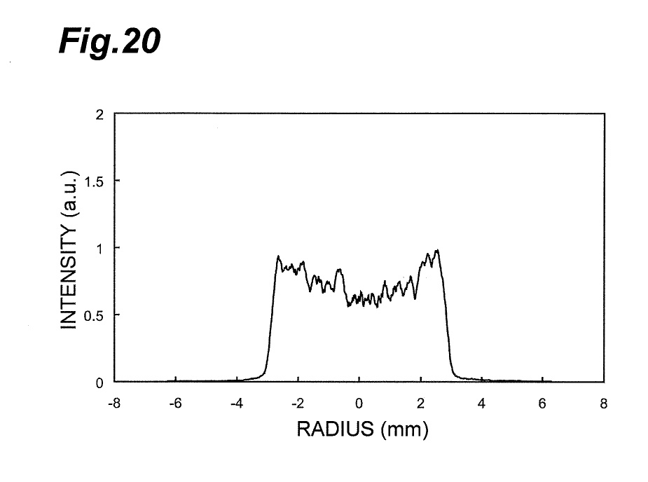

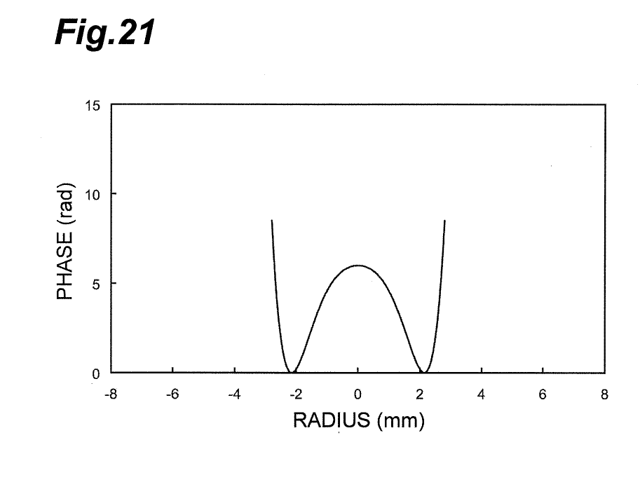

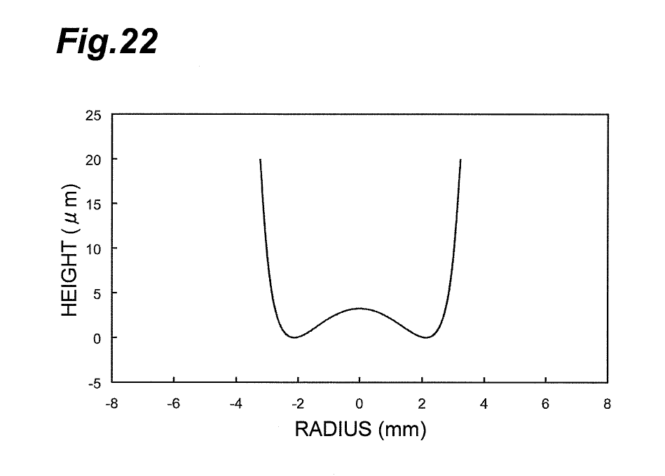

Then, as illustrated in FIG. 20, a desirable intensity distribution was obtained at 215 mm from the intensity conversion lens 11Y. FIG. 21 illustrates the wavefront of the laser light measured at this position. As in the form design of the aspheric surface mentioned above, the form of the aspheric surface 12a of the phase correction lens 12Y at 215 mm from the intensity conversion lens 11Y was determined as illustrated in FIG. 22.

MgF₂ (n=1.377) was also used as a material for the phase correction lens 12Y. For clarifying how the difference in height of the aspheric surfaces varies, the origin (the position where the height is 0 μm) of the ordinate also differs from the center (where the radius is 0 mm) of the aspherical lens 12X in FIG. 22.

### [Comparative Validation]

When the intensity distributions (FIGS. 16 and 20) and wavefronts (FIGS. 17 and 21) in the phase correction lenses 12, 12Y were compared with each other, it was found that the first example was able to expand the laser light by about 61.5/41=1.5 times, which corresponded to the magnifying power of the expansion optical system 20, by placing the expansion optical system 20 between the intensity conversion lens 11 and the phase correction lens 12.

For expanding the laser light as such, no needs were seen for changing the form of the aspheric surface 11a of the intensity conversion lens 11 and increasing the area and difference in height of the aspheric surface 11a (FIG. 15). It was also found that, as illustrated in FIGS. 18 and 22, the phase correction lens 12 merely increased its area in proportion to the magnifying power of the expansion optical system 20, while keeping the difference in height of the aspherical lens 12a at substantially the same level. Hence, the first example can inhibit the processing time for the intensity conversion lens 11 and phase correction lens 12 from increasing.

### Second Embodiment

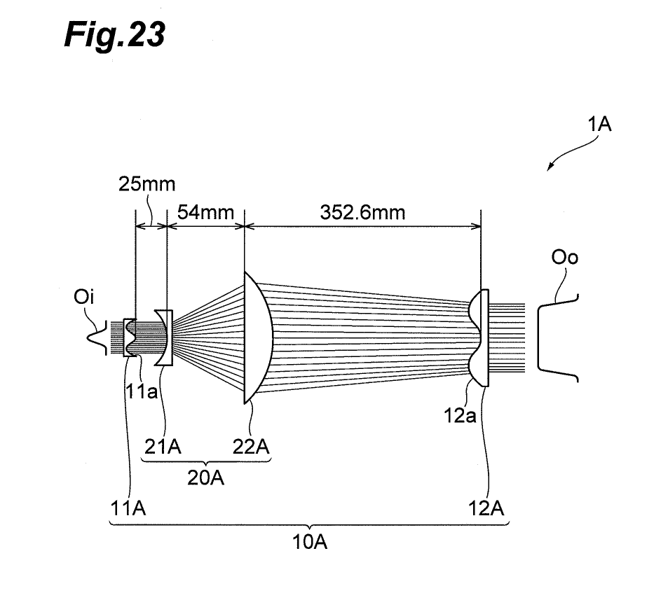

FIG. 23 is a structural diagram illustrating the laser light shaping optical system in accordance with the second embodiment of the present invention. This laser light shaping optical system 1A in accordance with the second embodiment comprises a homogenizer 10A constituted by a pair of aspherical lenses 11A, 12A and an expansion optical system 20A disposed between the pair of aspherical lenses 11A, 12A.

As with the above-mentioned homogenizer 10, the homogenizer 10A is used for shaping an intensity distribution of laser light into a given form and comprises the pair of aspherical lenses 11A, 12A. The aspherical lens 11A on the entrance side functions as an intensity conversion lens for shaping the intensity distribution of the laser light into a given form as with the above-mentioned aspherical lens 11. On the other hand, as with the above-mentioned aspherical lens 12, the aspherical lens 12A on the exit side functions as a phase correction lens for homogenizing the phase of the shaped laser light, so as to correct it into a plane wave. More specifically, the phase correction lens 12A homogenizes the phase of the laser light having the intensity distribution shaped by the intensity conversion lens 11A and then the beam diameter expanded by the expansion optical system 20A, which will be explained later, so as to correct it into a plane wave. As mentioned above, by designing the forms of the aspheric surfaces 11a, 12a in the pair of aspherical lenses 11A, 12A, the homogenizer 10A can also produce the output laser light Oo having a desirable intensity distribution into which the intensity distribution of the input laser light Oi is shaped. The expansion optical systems 20A is placed between the intensity conversion lens 11A and the phase correction lens 12A.

The expansion optical system 20A is used for expanding the beam diameter of the laser light emitted from the intensity conversion lens 11A and comprises a pair of concave and convex lenses 21A, 22A. The concave lens 21A is arranged on the intensity conversion lens 11A side and has a concave entrance surface and a planar exit surface. On the other hand, the convex lens 22A is arranged on the phase correction lens 12A side and has a planar entrance surface and a convex exit surface. No converging point exists between the pair of concave and convex lenses 21A, 22A in the expansion optical system 20A. According to the respective focal lengths of the pair of concave and convex lenses 21A, 22A, the expansion optical system 20A can expand the beam diameter of the laser light emitted from the intensity conversion lens 11A into a given size.

The laser light shaping optical system 1A in accordance with the second embodiment can also yield advantages similar to those of the laser light shaping optical system 1 in accordance with the first embodiment.

When practical use is taken into consideration, however, the expansion optical system 20 in the first embodiment once converges (crosses) a beam and then expands it, which increases the optical path length and may cause air breakdown at the converging point (cross point). In terms of optical design, on the other hand, another optical element (such as a reflector for monitoring) cannot be arranged within the expansion optical system even when required, since the light intensity is so strong near the converging point that the optical element may be damaged.

Since the expansion optical system 20A is constituted by the concave and convex lenses 21A, 22A, by contrast, no converging point (cross point) exists in the laser light shaping optical system 1A in accordance with the second embodiment. This can reduce the optical path length while preventing air breakdown from occurring at the converging point. Also, optical elements arranged within the expansion optical system, if any, are not damaged, which is advantageous in that the degree of freedom in optical design is high, whereby further smaller sizes can be achieved.

### Second Example

The laser light shaping optical system 1A in accordance with the second embodiment was designed as a second example. In the second example, as in FIG. 13, the laser light generated by the laser light source 30 was supposed to be expanded by the expander 40 and then made incident on the laser light shaping optical system 1A. Therefore, the form of the aspheric surface 11a of the intensity conversion lens 11A is the same as that of the aspheric surface 11a of the intensity conversion lens 11 (FIG. 15).

Employed in the expansion optical system 20A were a diffusing lens 21A made of BK7 having a thickness of 2 mm and a focal length of 102.4 mm and a condenser lens 22A made of BK7 having a thickness of 3 mm and a focal length of 153.7 mm.

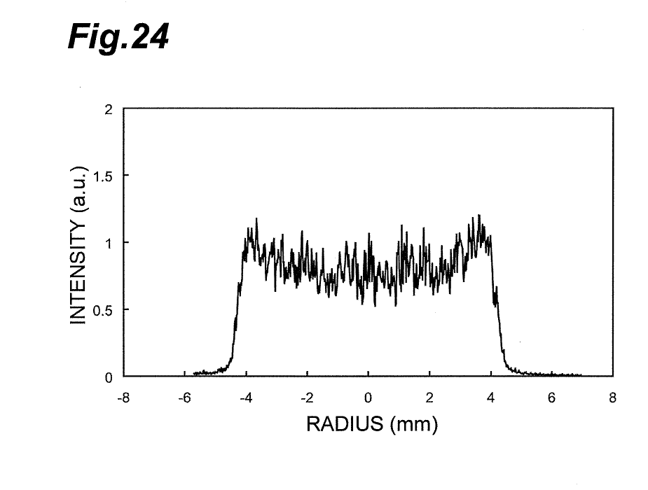

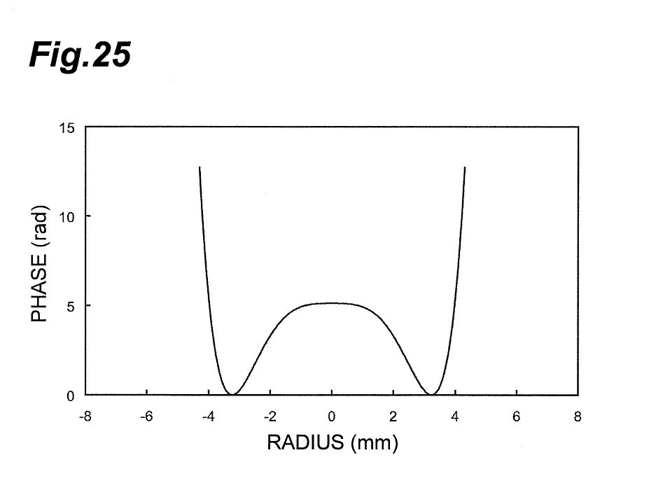

Then, as illustrated in FIG. 24, a desirable intensity distribution was obtained at 431.6 mm from the intensity conversion lens 11A. FIG. 25 illustrates the wavefront of the laser light measured at this position. As in the form design of the aspheric surface mentioned above, the form of the aspheric surface 12a of the phase correction lens 12 at 431.6 mm from the intensity conversion lens 11A was determined.

Here, the design was made while using MgF₂ (n=1.377) as a material for the intensity conversion lens 11A and phase correction lens 12A, setting the distance between the center position of the aspheric surface 11a and the center position of the aspheric surface 12a in the state without the expansion optical system 20A as L=215 mm, and taking account of the change in the optical path caused by inserting the expansion optical system 20A therein.

The second example was also able to expand the laser light by about 61.5/41=1.5 times, which corresponded to the magnifying power of the expansion optical system 20A, by placing the expansion optical system 20A between the intensity conversion lens 11A and the phase correction lens 12A.

For expanding the laser light as such, no needs were seen for changing the form of the aspheric surface 11a of the intensity conversion lens 11A and increasing the area and difference in height of the aspheric surface 11a. It was also found that the phase correction lens 12A merely increased its area in proportion to the magnifying power of the expansion optical system 20A, while keeping the difference in height of the aspherical lens 12a at substantially the same level. This can inhibit the processing time for the intensity conversion lens 11A and phase correction lens 12A from increasing.

While the first example obtained a uniform intensity distribution at 530 mm from the intensity conversion lens 11, the second example was able to yield a uniform intensity distribution at 431.6 mm from the intensity conversion lens 11A. That is, the second example was seen to be able to reduce the optical path length.

### Third Embodiment

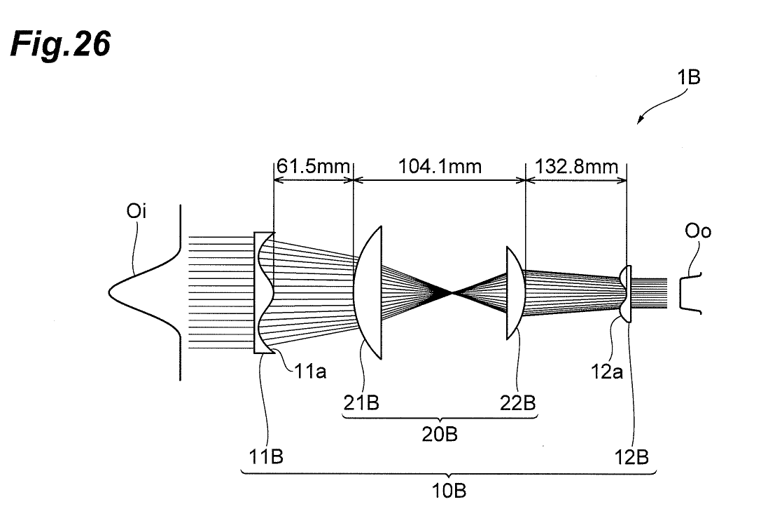

FIG. 26 is a structural diagram illustrating the laser light shaping optical system in accordance with the third embodiment of the present invention. This laser light shaping optical system 1B in accordance with the third embodiment comprises a homogenizer 10B constituted by a pair of aspherical lenses 11B, 12B and a reduction optical system 20B disposed between the pair of aspherical lenses 11B, 12B.

As with the above-mentioned homogenizer 10, the homogenizer 10B is used for shaping an intensity distribution of laser light into a given form and comprises the pair of aspherical lenses 11B, 12B. The aspherical lens 11B on the entrance side functions as an intensity conversion lens for shaping the intensity distribution of the laser light into a given form as with the above-mentioned aspherical lens 11. On the other hand, as with the above-mentioned aspherical lens 12, the aspherical lens 12B on the exit side functions as a phase correction lens for homogenizing the phase of the shaped laser light, so as to correct it into a plane wave. More specifically, the phase correction lens 12B homogenizes the phase of the laser light having the intensity distribution shaped by the intensity conversion lens 11B and then the beam diameter reduced by the reduction optical system 20B, which will be explained later, so as to correct it into a plane wave. As mentioned above, by designing the forms of the aspheric surfaces 11a, 12a in the pair of aspherical lenses 11B, 12B, the homogenizer 10B can also produce the output laser light Oo having a desirable intensity distribution into which the intensity distribution of the input laser light Oi is shaped. The reduction optical system 20B is placed between the intensity conversion lens 11B and the phase correction lens 12B.

The reduction optical system 20B is used for reducing the beam diameter of the laser light emitted from the intensity conversion lens 11B and comprises a pair of convex lenses 21B, 22B. The convex lens 21B is arranged on the intensity conversion lens 11B side and has a convex entrance surface and a planar exit surface. On the other hand, the convex lens 22B is arranged on the phase correction lens 12 side and has a planar entrance surface and a convex exit surface. A converging point exists between the pair of convex lenses 21B, 22B in the reduction optical system 20B. According to the respective focal lengths of the pair of convex lenses 21B, 22B, the reduction optical system 20B can reduce the beam diameter of the laser light emitted from the intensity conversion lens 11B into a given size.

In the laser light shaping optical system 1B in accordance with the third embodiment, the reduction optical system 20B arranged between the intensity conversion lens 11B and the phase correction lens 12B reduces the laser light, whereby it is sufficient for the intensity conversion lens 11B to shape the intensity distribution of the laser light. This can inhibit the intensity conversion lens 11B from increasing the difference in height of its aspheric surface and prolonging its processing time. This can also inhibit the phase correction lens 12B from increasing the difference in height of its aspheric surface and prolonging its processing time.

### Third Example

The laser light shaping optical system 1B in accordance with the third embodiment was designed as a third example. In the third example, as in FIG. 13, the laser light generated by the laser light source 30 was supposed to be expanded by the expander 40 and then made incident on the laser light shaping optical system 1B. Therefore, the form of the aspheric surface 11a of the intensity conversion lens 11B is the same as that of the aspheric surface 11a of the intensity conversion lens 11 (FIG. 15).

Employed in the reduction optical system 20B were a condenser lens 21B made of BK7 having a thickness of 3.6 mm and a focal length of 61.5 mm and a condenser lens 22B made of BK7 having a thickness of 4.6 mm and a focal length of 41 mm.

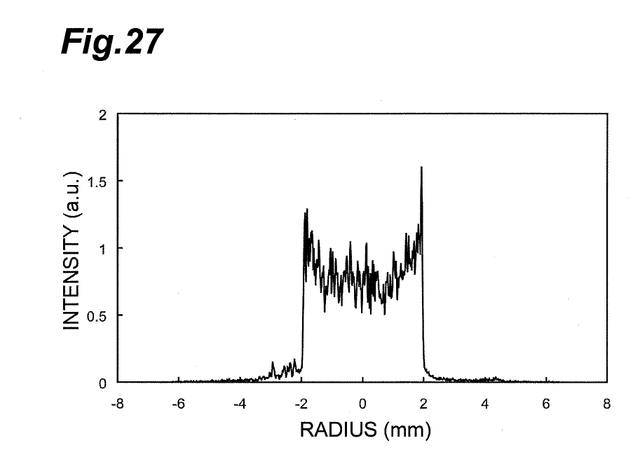

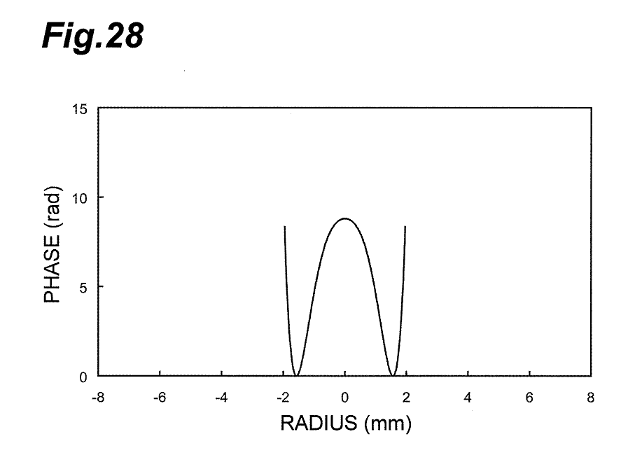

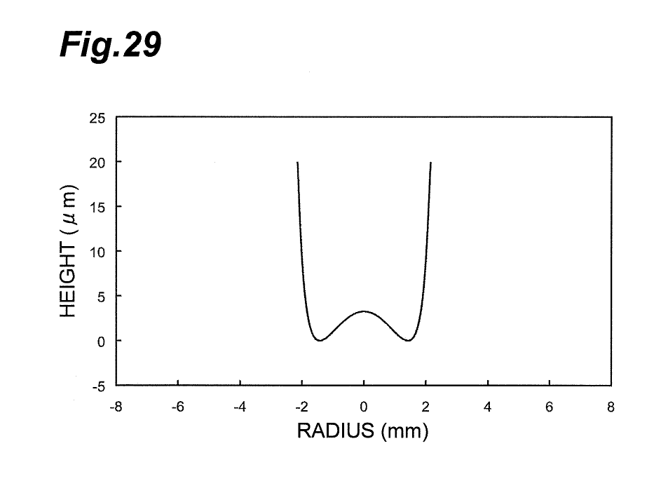

Then, as illustrated in FIG. 27, a desirable intensity distribution was obtained at 530 mm from the intensity conversion lens 11B. FIG. 28 illustrates the wavefront of the laser light measured at this position. As in the form design of the aspheric surface mentioned above, the form of the aspheric surface 12a of the phase correction lens 12B at 530 mm from the intensity conversion lens 11B was determined as illustrated in FIG. 29.

Here, the design was made while using MgF₂ (n=1.377) as a material for the intensity conversion lens 11B and phase correction lens 12B, setting the distance between the center position of the aspheric surface 11a and the center position of the aspheric surface 12a in the state without the reduction optical system 20B as L=215 mm, and taking account of the change in the optical path caused by inserting the reduction optical system 20B therein. For clarifying how the difference in height of the aspheric surfaces varies, the origin (the position where the height is 0 μm) of the ordinate also differs from the centers (where the radius is 0 mm) of the aspherical lenses 11B, 12B in FIG. 29.

The third example was also able to reduce the laser light by about 41/61.5=2/3, which corresponded to the reducing power of the reduction optical system 20B, by placing the reduction optical system 20B between the intensity conversion lens 11B and the phase correction lens 12B.

For reducing the laser light as such, no needs were seen for changing the form of the aspheric surface 11a of the intensity conversion lens 11B and increasing the area and difference in height of the aspheric surface 11a. It was also found that the phase correction lens 12B merely increased its area in proportion to the reducing power of the reduction optical system 20B, while keeping the difference in height of the aspherical lens 12a at substantially the same level. This can inhibit the processing time for the intensity conversion lens 11B and phase correction lens 12B from increasing.

### Fourth Embodiment

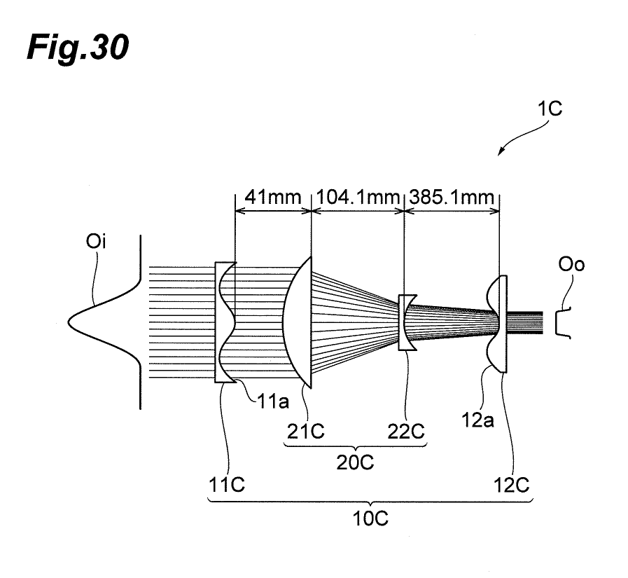

FIG. 30 is a structural diagram illustrating the laser light shaping optical system in accordance with the fourth embodiment of the present invention. This laser light shaping optical system 1C in accordance with the fourth embodiment comprises a homogenizer 10C constituted by a pair of aspherical lenses 11C, 12C and a reduction optical system 20C disposed between the pair of aspherical lenses 11C, 12C.

As with the above-mentioned homogenizer 10, the homogenizer 10C is used for shaping an intensity distribution of laser light into a given form and comprises the pair of aspherical lenses 11C, 12C. The aspherical lens 11C on the entrance side functions as an intensity conversion lens for shaping the intensity distribution of the laser light into a given form as with the above-mentioned aspherical lens 11. On the other hand, as with the above-mentioned aspherical lens 12, the aspherical lens 12C on the exit side functions as a phase correction lens for homogenizing the phase of the shaped laser light, so as to correct it into a plane wave. More specifically, the phase correction lens 12C homogenizes the phase of the laser light having the intensity distribution shaped by the intensity conversion lens 11C and then the beam diameter reduced by the reduction optical system 20C, which will be explained later, so as to correct it into a plane wave. As mentioned above, by designing the forms of the aspheric surfaces 11a, 12a in the pair of aspherical lenses 11C, 12C, the homogenizer 10C can also produce the output laser light Oo having a desirable intensity distribution into which the intensity distribution of the input laser light Oi is shaped. The reduction optical system 20C is placed between the intensity conversion lens 11C and the phase correction lens 12C.

The reduction optical system 20C is used for reducing the beam diameter of the laser light emitted from the intensity conversion lens 11C and comprises a pair of convex and concave lenses 21C, 22C. The convex lens 21C is arranged on the intensity conversion lens 11C side and has a convex entrance surface and a planar exit surface. On the other hand, the concave lens 22C is arranged on the phase correction lens 12C side and has a planar entrance surface and a concave exit surface. No converging point exists between the pair of convex and concave lenses 21C, 22C in the reduction optical system 20C. According to the respective focal lengths of the pair of convex and concave lenses 21C, 22C, the reduction optical system 20C can reduce the beam diameter of the laser light emitted from the intensity conversion lens 11C into a given size.

The laser light shaping optical system 1C in accordance with the fourth embodiment can yield advantages similar to those of the laser light shaping optical system 1B in accordance with the third embodiment.

Since the reduction optical system 20C is constituted by the convex and concave lenses 21C, 22C, no converging point (cross point) exists in the laser light shaping optical system 1C in accordance with the fourth embodiment as in the laser light shaping optical system 1A in accordance with the second embodiment. This can reduce the optical path length while preventing air breakdown from occurring at the converging point. Also, optical elements arranged within the expansion optical system, if any, are not damaged, which is advantageous in that the degree of freedom in optical design is high, whereby further smaller sizes can be achieved.

### Fourth Example

The laser light shaping optical system 1C in accordance with the fourth embodiment was designed as a fourth example. In the fourth example, as in FIG. 13, the laser light generated by the laser light source 30 was supposed to be expanded by the expander 40 and then made incident on the laser light shaping optical system 1C. Therefore, the form of the aspheric surface 11a of the intensity conversion lens 11C is the same as that of the aspheric surface 11a of the intensity conversion lens 11 (FIG. 15).

Employed in the reduction optical system 20C were a condenser lens 21C made of BK7 having a thickness of 3 mm and a focal length of 153.7 mm and a diffusing lens 22C made of BK7 having a thickness of 2 mm and a focal length of 102.4 mm.

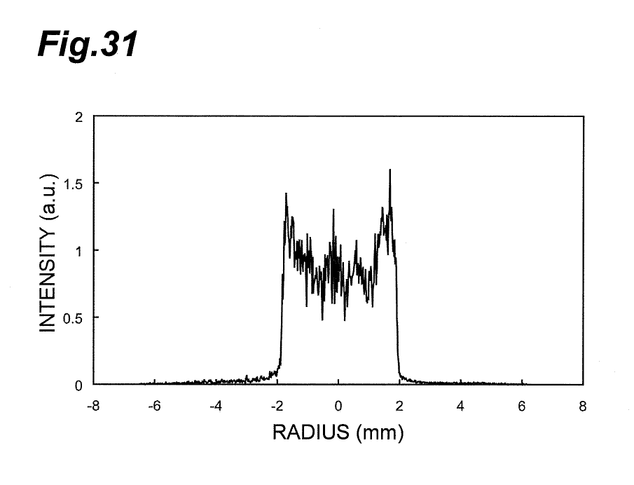

Then, as illustrated in FIG. 31, a desirable intensity distribution was obtained at 431.6 mm from the intensity conversion lens 11C.

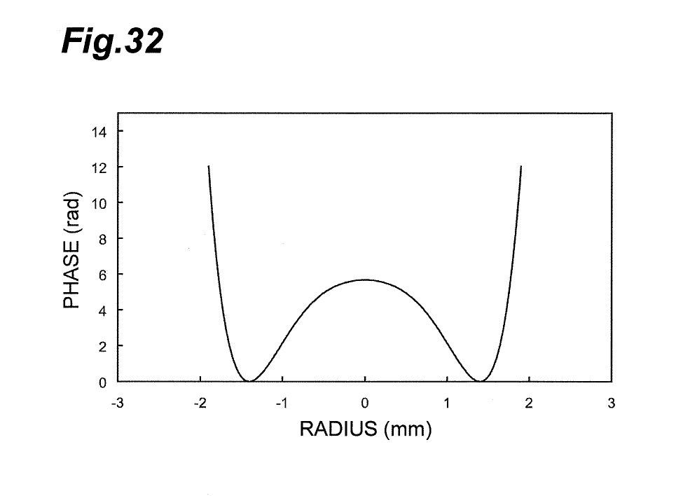

FIG. 32 illustrates the wavefront of the laser light measured at this position. As in the form design of the aspheric surface mentioned above, the form of the aspheric surface 12a of the phase correction lens 12C at 431.6 mm from the intensity conversion lens 11C was determined.

Here, the design was made while using MgF₂ (n=1.377) as a material for the intensity conversion lens 11C and phase correction lens 12C, setting the distance between the center position of the aspheric surface 11a and the center position of the aspheric surface 12a in the state without the reduction optical system 20C as L=215 mm, and taking account of the change in the optical path caused by inserting the reduction optical system 20C therein.

The fourth example was also able to reduce the laser light by about 41/61.5=2/3, which corresponded to the reducing power of the reduction optical system 20C, by placing the reduction optical system 20C between the intensity conversion lens 11C and the phase correction lens 12C.

For reducing the laser light as such, no needs were seen for changing the form of the aspheric surface 11a of the intensity conversion lens 11C and increasing the area and difference in height of the aspheric surface 11a. It was also found that the phase correction lens 12C merely increased its area in proportion to the reducing power of the reduction optical system 20C, while keeping the difference in height of the aspherical lens 12a at substantially the same level. This can inhibit the processing time for the intensity conversion lens 11C and phase correction lens 12C from increasing.

While the third example obtained a uniform intensity distribution at 530 mm from the intensity conversion lens 11B, the fourth example was able to yield a uniform intensity distribution at 431.6 mm from the intensity conversion lens 11C. That is, the fourth example was seen to be able to reduce the optical path length.

The present invention can be modified in various ways without being restricted to the above-mentioned embodiments. For example, the phase correction lens may correct the wavefront in the embodiments. In this case, the wavefront of laser light at the position where the phase correction lens is arranged may be measured (e.g., FIGS. 17, 21, 25, 28, and 32), and the aspheric surface of the phase correction lens may be designed such as to correct the measured wavefront. This can also reduce wavefront distortions caused by optical elements other than the homogenizer within the optical system.

By adjusting the position of the expansion optical system or reduction optical system, the above-mentioned embodiments can set a given position as one where the laser light emitted from the intensity conversion lens has a desirable intensity distribution.

For example, when the diffusing lens 21A (made of BK7 having a thickness of 2 mm and a focal length of 102.4 mm) in the expansion optical system 20A is positioned at 5 mm from the intensity conversion lens 11A in the second example, the position where the laser light emitted from the intensity conversion lens 11A has a desirable intensity distribution is located at 441.3 mm from the intensity conversion lens 11A. When the diffusing lens 21A is positioned at 45 mm from the intensity conversion lens 11A, the position where the laser light emitted from the intensity conversion lens 11A has a desirable intensity distribution is located at 421.9 mm from the intensity conversion lens 11A. When the diffusing lens 21A is positioned at 65 mm from the intensity conversion lens 11A, the position where the laser light emitted from the intensity conversion lens 11A has a desirable intensity distribution is located at 412.3 mm from the intensity conversion lens 11A. When the diffusing lens 21A is positioned at 85 mm from the intensity conversion lens 11A, the position where the laser light emitted from the intensity conversion lens 11A has a desirable intensity distribution is located at 402.6 mm from the intensity conversion lens 11A. When the diffusing lens 21A is positioned at 105 mm from the intensity conversion lens 11A, the position where the laser light emitted from the intensity conversion lens 11A has a desirable intensity distribution is located at 393 mm from the intensity conversion lens 11A. When the diffusing lens 21A is positioned at 125 mm from the intensity conversion lens 11A, the position where the laser light emitted from the intensity conversion lens 11A has a desirable intensity distribution is located at 383.3 mm from the intensity conversion lens 11A. When the diffusing lens 21A is positioned at 145 mm from the intensity conversion lens 11A, the position where the laser light emitted from the intensity conversion lens 11A has a desirable intensity distribution is located at 373.3 mm from the intensity conversion lens 11A.

What is claimed is:

1. A laser light shaping optical system comprising:
an intensity conversion lens for converging and shaping an intensity distribution of laser light incident thereon into a desirable intensity distribution;
a phase correction lens for correcting the laser light emitted from the intensity conversion lens into a plane wave by homogenizing a phase thereof; and
an expansion/reduction optical system, arranged between the intensity conversion lens and the phase correction lens, for expanding or reducing the laser light emitted from the intensity conversion lens.

2. A laser light shaping optical system according to claim 1, wherein the expansion/reduction optical system is constituted by a pair of convex lenses.

3. A laser light shaping optical system according to claim 1, wherein the expansion/reduction optical system is constituted by a pair of concave and convex lenses.
